(19) United States
(12) Patent Application Publication
(10) Pub. No.: US 2005/0141546 A1
(43) Pub. Date: Jun. 30, 2005

(54) Method of avoiding collisions between access terminals

(75) Inventor: Jun Heo, Seoul (KR)

Correspondence Address: CANTOR COLBURN, LLP, 55 GRIFFIN ROAD SOUTH, BLOOMFIELD, CT, 06002, US

(73) Assignee: LG Electronics Inc., Seoul (KR)

(21) Appl. No.: 11/010,302

(22) Filed: Dec. 14, 2004

(30) Foreign Application Priority Data
Dec. 31, 2003 (KR) 10-2003-0101345
Jul. 13, 2004 (KR) 10-2004-0054427

(51) Int. Cl. H04L 12/40

(52) U.S. Cl. 370/447; 370/229

(57) ABSTRACT

A method of avoiding collisions in a mobile communication system having an access network and at least one access terminal. The method includes receiving, from the at least one access terminal, a service connection request message including an access terminal identifier and a time identifier, and comparing a time information of the received time identifier to a reset time of the at least one access network. Further, if the time information precedes the reset time as a result of the comparison, the method includes broadcasting a session close message including the access terminal identifier and the time identifier to the at least one access terminal.

### CROSS REFERENCE TO RELATED APPLICATIONS

This application claims the benefit of the Korean Applications No. P2003-0101345 filed on Dec. 31, 2003 and No. P2004-54427 filed on Jul. 13, 2004, which are hereby incorporated by reference in their entirety.

### BACKGROUND OF THE INVENTION

1. Field of the Invention

The present invention relates to a method of preventing a same unicast access terminal identifier (UATI) from being simultaneously allocated to separate access terminals (ATs), and more particularly to a method of preventing ATs from colliding with each other if a same UATI is allocated to different ATs when resetting an access network (AN).

2. Background of the Related Art

Generally, an AN allocates a UATI to each AT to identify the authenticated AT. In doing so, if an allocation and management unit of the AN is reset while a first AT having its allocated UATI closes a service, the entire UATI information of the AN is initialized. Further, the same UATI allocated to the first AT prior to the reset may be allocated to a second AT. When the first AT attempts a service using the same allocated UATI while the second AT receives a corresponding data service using its allocated UATI, the AN detects that the UATIs of the first and second ATs collide with each other and then requests the first AT to perform a service close operation.

However, at this time, a traffic channel has not yet been allocated, whereby the AN sends a service close message including the same UATI to both of the first and second ATs via a control channel. Thus, the first and second ATs are unable to receive the corresponding service using the UATI for a predetermined period of time.

Moreover, when adding a separate hard disc drive (HDD) to each base station controller (BSC) of the AN, an overall system cost will rise, an additional interface between a processor responsible for UATI allocation and management of the AN and the corresponding HDD is required, and an additional handling time is required for allocating and storing the UATI to the HDD per request of each AT to manage a result thereof

Turning now to FIG. 1, which is a flowchart of a UATI allocating method according to the related art. As shown, a first AT appends a first random access terminal identifier (RATI) to a UATI request message for a data service request and then transfers the appended message AN (S111).

Subsequently, the AN sends a response to the UATI request message of the first AT by allocating a UATI to the first AT (S112). The first AT then stores the allocated UATI in its memory (S113). The first AT having the allocated UATI is then able to receive a data service from the AN (S114). If the AN is reset after completion of the data service, a UATI database is initialized.

After the initialization of the UATI database of the AN, a second AT sends a UATI request message including a second RATI to the AN to request a data service (S116). The AN sends a response to the UATI request message of the second AT by allocating a UATI thereto (S117). The second AT then stores the UATI received from the AN in its memory (S118). The second AT is then able to receive a data service from the AN using the allocated UATI (S119).

In doing so, the UATI allocated to the second AT may be identical to the UATI allocated to the first AT which was allocated prior to resetting the AN. If so, the following problem occurs. Namely, the first AT having the UATI allocated prior to the reset of the AN sends a connection request message including the allocated UATI (S120). In this case, because a value of the UATI allocated to the first AT is equal to that allocated to the second AT, a collision between the UATIs occurs in the AN.

Further, once the AN having detected the collision sends a session close message including the UATI via a control channel (S121), both sessions of the first and second ATs are closed. However, as the UATI value of the first AT is equal to that of the second AT, collisions keep occurring after the section closes.

### SUMMARY OF THE INVENTION

Accordingly, one object of the invention is to solve at least the above problems and/or disadvantages and to provide at least the advantages described hereinafter.

Another object of the present invention is to avoid collisions between ATs by broadcasting a session close message including a UATI and time identifier to the ATs.

To achieve these objects and other advantages and in accordance with the purpose of the invention, as embodied and broadly described herein, the present invention provides a novel method of avoiding collisions in a mobile communication system having an access network and at least one access terminal. The method includes receiving, from the at least one access terminal, a service connection request message including an access terminal identifier and a time identifier, and comparing a time information of the received time identifier to a reset time of the at least one access network. Further, if the time information precedes the reset time as a result of the comparison, the method includes broadcasting a session close message including the access terminal identifier and the time identifier to the at least one access terminal.

Therefore, the present invention prevents collisions between the access terminals due to a same UATI allocation without adding a separate hard disc drive (HDD) to each base station controller (BSC) of the access network (AN).

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a flowchart of a UATI allocating method according to the related art;

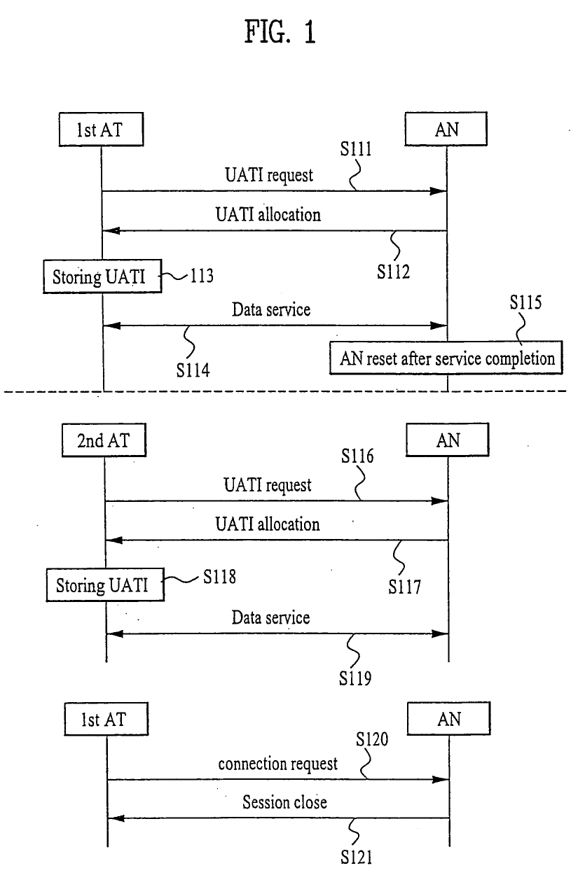

FIG. 2 is a flowchart of a UATI allocating method according to the present invention;

FIG. 3 is a flowchart of an operation of an AN for avoiding collisions between ATs according to a first embodiment of the present invention;

FIG. 4 is a flowchart of an operation of an AN for avoiding collisions between ATs according to a second embodiment of the present invention;

FIG. 5 is a flowchart of an operation of an AN for avoiding collisions between ATs according to a third embodiment of the present invention;

FIG. 6 is a flowchart of an operation of an AN for avoiding collisions between ATs according to a fourth embodiment of the present invention; and

FIG. 7 is a flowchart of a session close operation of an AT according to the present invention.

### BEST MODE OF THE INVENTION

Referring now to the drawings, wherein like reference numerals designate identical or corresponding parts throughout the several views, the present invention will be described.

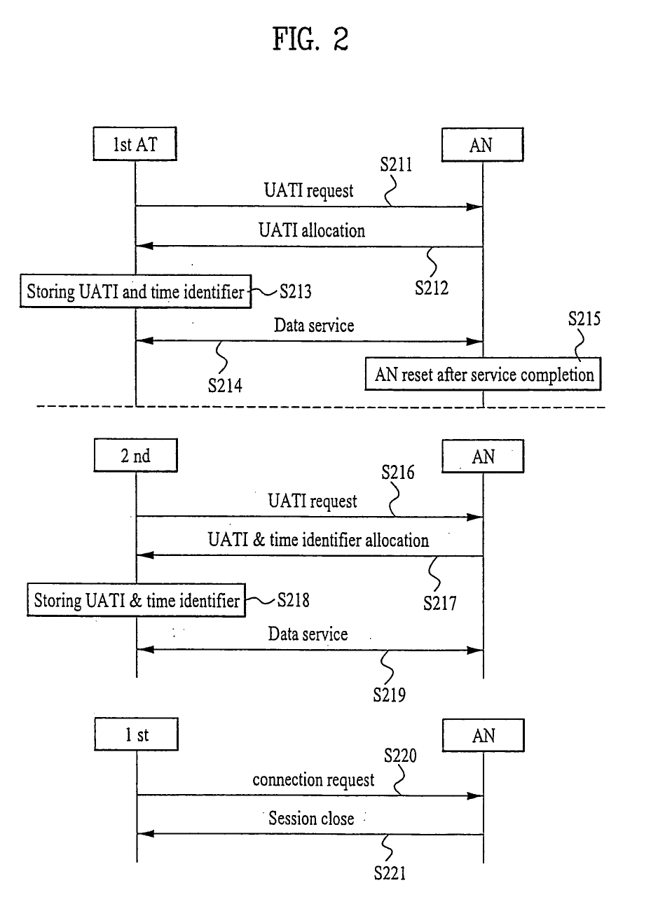

First, FIG. 2 is a flowchart of a UATI allocating method according to the present invention. As shown, a first AT transfers a UATI request message for a service request to an AN (S211). The AN then allocates a UATI and time identifier in response to the UATI request message and sends the response to the first AT (S212). The time identifier includes information such as time at which the allocation of the UATI was made including a date, hour, minute, and second, for example.

The first AT renders the UATI and time identifier transferred from the AN into one pair and stores the corresponding pair in its memory (S213). A non-volatile memory such as an EEPROM (electrically programmable read only memory), etc. may be used as the memory to prevent the stored information from being lost if or when the power of the AT is turned off.

Meanwhile, the first AT uses the pair of the allocated UATI and time identifier in requesting a service again after completing a previous service. After the first AT has received the service from the AN using the pair of the allocated UATI and time identifier (S214), a UATI database of the AN is initialized if the AN is reset after completion of the service (S215).

As shown, after the AN has been reset, a second AT transfers a UATI request message including a second RATI service request to the AN (S216). The AN then allocates a UATI and time identifier in response to the UATI request message of the second AT and then transfers the response to the second AT (S217). The second AT also renders the UATI and time identifier transferred from the AN into one pair and stores the corresponding pair in its memory (S218).

The second AT then receives a service from the AN using the pair of the allocated UATI and time identifier (S219). Meanwhile, the first AT having the previously allocated UATI transfers a connection request message including the UATI and time identifier pair to the AN to receive another service from the AN (S220).

In this instance, the UATI allocated to the second AT may be identical to that allocated to the first AT. Namely, because the UATI of the second AT was newly allocated after the initialization of the UATI database of the AN, the AN may allocate the same UATI to the second AT without recognizing the same UATI was already allocated to the first AT. Hence, when the first AT requests a service using the UATI allocated prior to the initialization of the UATI database of the AN, a collision with the UATI of the second AT occurs.

However, according to the present invention, if at least two or more ATs having the same UATI collide with each other, they can be identified using the time identifiers. In addition, the UATI and time identifier initialization for the rest of the ATs except one UATI/time identifier can be requested by broadcasting via a control channel.

The AN, as shown in FIG. 2, transfers a session close message including the UATI and time identifier to each of the ATs (S221). The first AT then compares the UATI stored in its memory to the UATI transferred from the AN. If the UATIs are identical to each other as a result of the comparison, the first AT compares the time identifier stored in its memory to the time identifier transferred from the AN. If the time identifiers are identical to each other, the first AT initializes the UATI and time identifier stored in its memory.

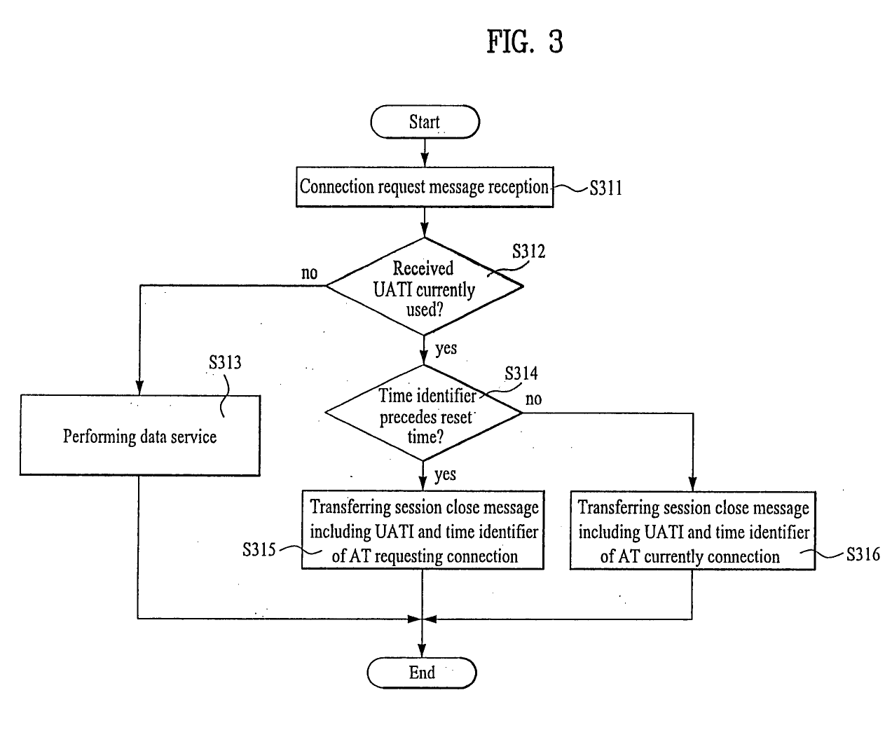

Turning now to FIG. 3, which is a flowchart of an operation of an AN for avoiding collisions between ATs according to a first embodiment of the present invention. As shown, an AN receives a connection request message transferred from an AT (S311). As discussed above, the connection request message transferred from the AT includes a UATI and time identifier allocated to the AT. The AN then checks whether a UATI identical to the UATI included in the connection request message is being used by another AT (S312). If the UATI is not in use as a result of the check, the AN performs a data service on the AT having transferred the connection request message using the UATI (S313).

However, if the UATI is already in use as a result of the check, the AN compares the time identifier included in the connection request message to its reset time (S314). If the time identifier is prior to the reset time as result of the comparison, the AN determines that the UATI was allocated prior to the reset. Thus, when the UATI allocated before the reset is being used by the requesting AT, the AN decides that the UATI of the AT is not valid anymore. Hence, the AN transfers a session close message including the UATI and time identifier of the AT to the requesting AT by broadcasting via a control channel (S315).

Meanwhile, if the time identifier is later than the reset time as result of the comparison (S314), the AN determines that the UATI was allocated after the reset. Namely, the AN determines the AT is valid.

The AN can also determine that the UATI of the another AT using the same UATI is not valid (because the UATI of the requesting AT is valid). Thus, the AN transfers a session close message including the UATI and time identifier to the another AT by broadcasting via a control channel (S316). The AN then performs a data service for the requesting AT.

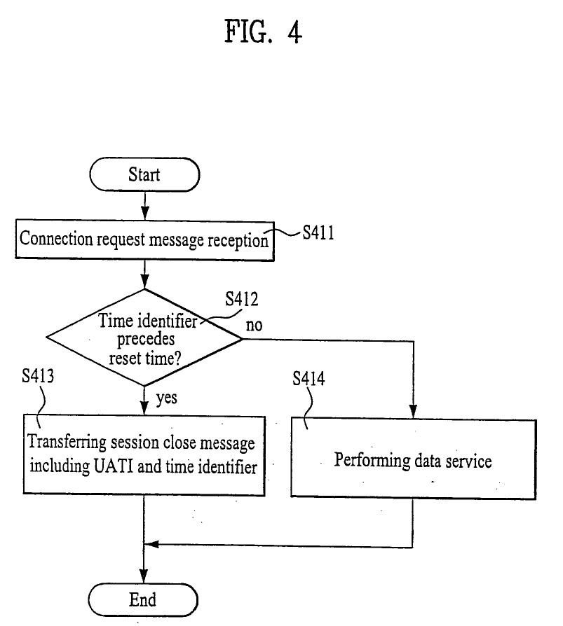

Next, FIG. 4 is a flowchart of an operation of an AN for avoiding collisions between ATs according to a second embodiment of the present invention. As shown, an AN receives a connection request message transferred from an AT (S411). Further, the connection request message transferred from the AT includes a UATI and time identifier allocated to the AT. The AN then compares the time identifier included in the connection request message to its rest time (S412).

If the time identifier is prior to the reset time as result of the comparison, the AN determines that the UATI was allocated prior to the reset. Thus, the AN determines that the UATI allocated prior to the reset is not valid. Hence, the AN transfers a session close message including the UATI and time identifier to the AT by broadcasting via a control channel (S413).

Meanwhile, if the time identifier is later than the reset time as result of the comparison (S412), the AN determines that the UATI was allocated after the reset. Thus, the AN determines that the UATI of the AT is valid. Thus, the AN performs a data service on the AT (S414).

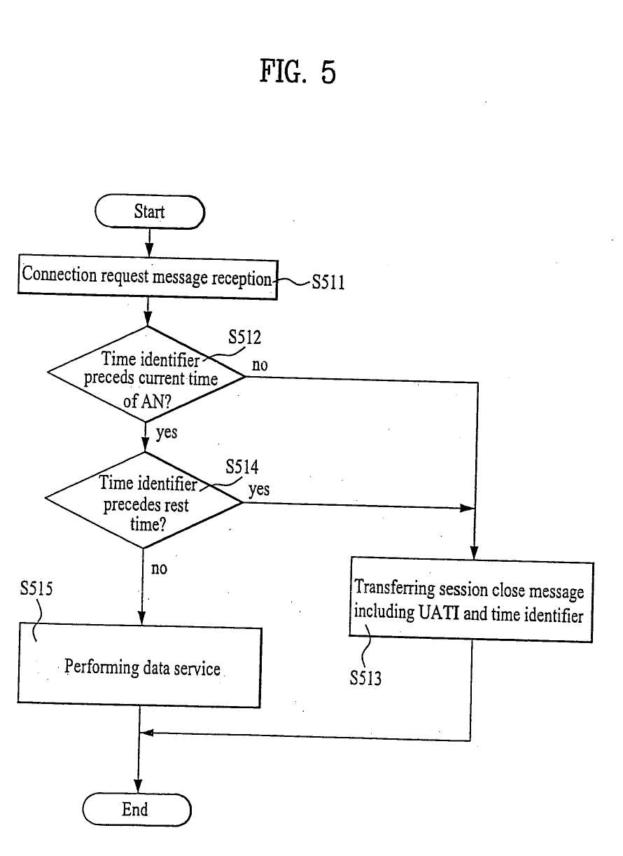

Turning now to FIG. 5, which is a flowchart of an operation of an AN for avoiding collisions between ATs according to a third embodiment of the present invention. As shown, an AN receives a connection request message transferred from an AT (S511). As discussed above, the connection request message includes a UATI and time identifier allocated to the AT. The AN then compares the time identifier included in the connection request message to a current time of the AN (S512). Because the time identifier includes information about the date (e.g., month, day, year), time, minute, and second of the UATI allocation time, the AN can determine that at least one month has passed since the allocation time if the information of the time identifier of the UATI transferred from the AT is later than the current time of the AN. Hence, in this instance, the AN determines that the received UATI is not valid. Thus, when receiving the invalid UATI, the AN transfers a session close message including the UATI and time identifier by broadcasting via a control channel (S513).

However, if the information about the date, time, minute, and second of the UATI transferred from the AT precedes the current time of the AN, the AN determines once that the UATI is valid. Further, the time identifier included in the connection request message is also compared to a reset time of the AN (S514). If the time identifier precedes the reset time as a result of the comparison, the AN determines that the UATI was allocated prior to the reset. Hence, the AN determines that the UATI allocated prior to the reset is not valid and transfers a session close message including the UATI and time identifier to the AT by broadcasting via a control channel (S513).

Meanwhile, if the time identifier is later than the reset time as result of the comparison (S514), the AN determines that the UATI was allocated after the reset. The AN then determines that the UATI, which is allocated after the reset, is valid. The AN then performs a data service on the AT (S515).

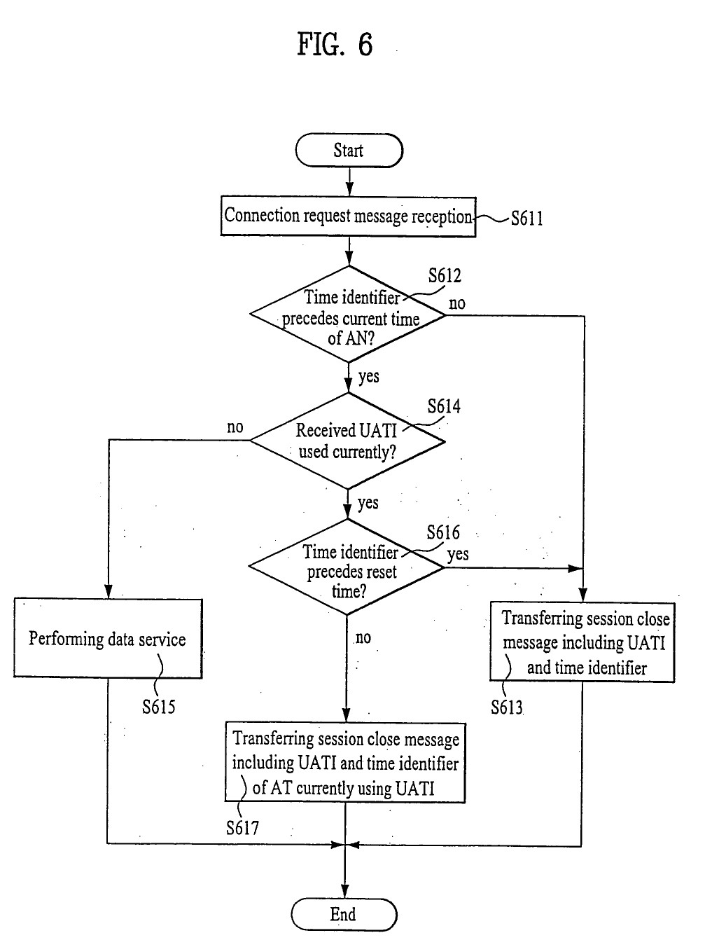

Next, FIG. 6 is a flowchart of an operation of an AN for avoiding collisions between ATs according to a fourth embodiment of the present invention. As shown, an AN receives a connection request message including a UATI and time indentifier transferred from an AT (S611). The AN compares the time identifier included in the connection request message to a current time of the AN (S612).

As discussed above, because the time identifier includes information about a date, time, minute, and second of the UATI allocation time, the AN can determine that at least one month has passed since the UATI was allocated if the time information of the UATI is later than the current time of the AN. Hence, the AN determines that the received UATI is not valid. When receiving the invalid UATI, the AN transfers a session close message including the UATI and time identifier to the AT by broadcasting via a control channel (S613).

However, if the time information of the UATI precedes the current time of the AN, the AN determines once that the UATI is valid. Subsequently, the AN checks whether the same UATI included in the connection request message is being used by another AT (S614). If the same UATI is not being used as a result of the check, the AN performs a data service on the AT having transferred the connection request message using the UATI (S615). However, if the same UATI is being used as a result of the check, the AN compares the time identifier included in the connection request message to a reset time of the AN (S616).

If the time identifier precedes the reset time as a result of the comparison, the AN determines that the UATI was allocated prior to the reset. Thus, if the UATI allocated before the reset is being used by the requesting AT, the AN determines that the UATI of the AT is not valid anymore. Hence, the AN transfers a session close message including the UATI and time identifier to the AT to the requesting AT by broadcasting via a control channel (S613).

Meanwhile, if the time identifier is later than the reset time as result of the comparison (S616), the AN determines that the UATI was allocated after the reset. Namely, the AN determines that the UATI, which is allocated after the reset, is valid. Hence, the AN can also determine that the UATI of another AT, which is using the same UATI, is not valid. The AN then transfers a session close message including the UATI and time identifier to the AT by broadcasting via control channel (S617). In such a case, the AN performs a data service on the requesting AT.

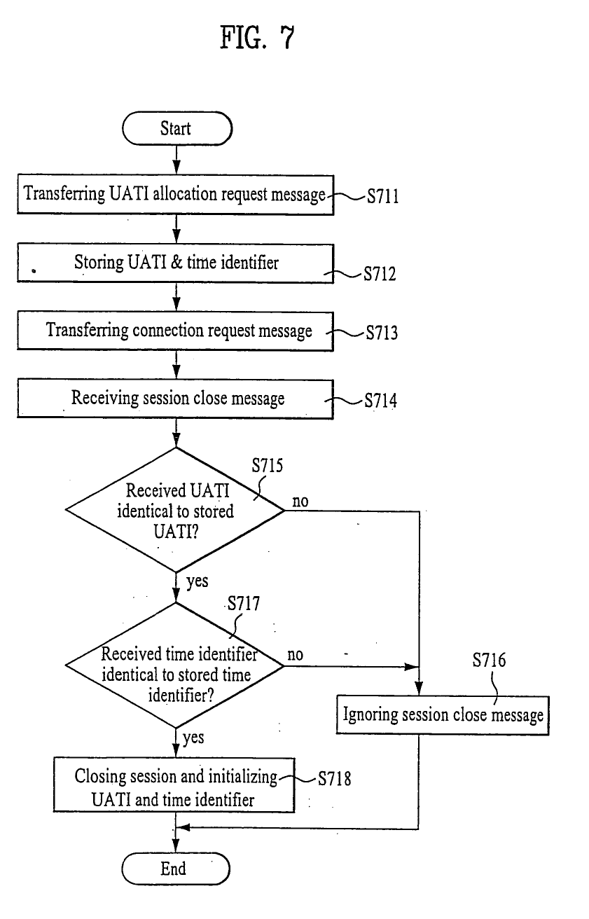

Next, FIG. 7 is a flowchart of a session close operation of an AT according to the present invention. As shown, an AT transfers a message for requesting UATI allocation to an AN to receive a service (S711). When receiving the UATI and time identifier from the AN, the AT renders them into one pair and then stores the corresponding pair in a memory (S712).

An operation of the AT after the UATI allocation is explained as follows. First, the AT transfers a connection request message including the pair of the UATI and time identifier allocated to itself after the UATI allocation to the AN (S713). When receiving a session close message from the AN (S714), the AT compares the UATI included in the session close message to its UATI (S715).

If the UATIs are not identical to each other as a result of the comparison, the AT ignores the session close message (S716). However, if the UATIs are identical, the AT compares the time identifier included in the session close message to its time identifier (S717). If the time identifiers are not identical to each other as a result of the comparison, the AT ignores the session close message (S716). However, if the time identifiers are identical, the AT closes the corresponding session and initializes its UATI and time identifier (S718).

This invention may be conveniently implemented using a conventional general purpose digital computer or microprocessor programmed according to the teachings of the present specification, as well be apparent to those skilled in the computer art. Appropriate software coding can readily be prepared by skilled programmers based on the teachings of the present disclosure, as will be apparent to those skilled in the software art.

The invention may also be implemented by the preparation of application specific integrated circuits or by interconnecting an appropriate network of conventional component circuits, as will be readily apparent to those skilled in the art. The present invention includes a computer program product which is a storage medium including instructions which can be used to program a computer to perform a process of the invention. The storage medium can include, but is not limited to, any type of disk including floppy disks, optical discs, CD-ROMs, and magneto-optical disks, ROMs, RAMs, EPROMs, EEPROMs, magnetic or optical cards, or any type of media suitable for storing electronic instructions.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

1. A method of avoiding collisions in a mobile communication system having an access network and at least one access terminal, comprising:
receiving, from the at least one access terminal, a service connection request message including an access terminal identifier and a time identifier;
comparing a time information of the received time identifier to a reset time of the at least one access network; and
if the time information precedes the reset time as a result of the comparison, broadcasting a session close message including the access terminal identifier and the time identifier to the at least one access terminal.

2. The method of claim 1, further comprising performing a data service on the at least one access terminal if the time information is later than the reset time as the result of the comparison.

3. The method of claim 1, wherein the time identifier comprises a system time information indicating when the access network allocates the access terminal identifier to the at least one access terminal.

4. The method of claim 1, wherein the access terminal identifier is a unicast access terminal identifier.

5. The method of claim 1, wherein the session close message including the access terminal identifier and the time identifier is transferred via a control channel.

6. A method of avoiding collisions in a mobile communication system having an access network and at least a first and second access terminal, comprising:
receiving a service connection request message including a first access terminal identifier and a first time identifier from the first access terminal;
checking whether or not the second access terminal is using an identical access terminal identifier as the received first access terminal identifier;
if the second access terminal is using the identical access terminal identifier, comparing a time information of the first time identifier to a reset time of the access network; and
if the time information precedes the reset time as a result of the comparison, broadcasting a session close message including the first access terminal identifier and the first time identifier to the first access terminal.

7. The method of claim 6, further comprising performing a data service on the first access terminal if the second access terminal is not using the identical access terminal identifier.

8. The method of claim 6, further comprising broadcasting another session close message including the second access terminal identifier and the second time identifier to the second access terminal if the time information is later than the reset time as a result of the comparison.

9. A method of avoiding collisions in a mobile communication system having an access network and at least one access terminal, comprising:
receiving a service connection request message including an access terminal identifier and a time identifier from the at least one access terminal;
comparing a time information of the received time identifier to a current system time of the access network;
if the time information precedes the current system time, comparing the time information to a reset time of the access network; and
if the time information precedes the reset time, broadcasting a session close message including the access terminal identifier and the time identifier to the at least one access terminal.

10. The method of claim 9, further comprising broadcasting the session close message including the access terminal identifier and the time identifier to the at least one access terminal if the time information is later than the current system time.

11. The method of claim 9, further comprising performing a data service on the at least one access terminal if the time information is later than the reset time.

12. The method of claim 9, wherein the access terminal identifier is a unicast access terminal identifier.

13. A method of avoiding collisions in a mobile communication system having an access network and at least a first and a second access terminal, comprising:
receiving a service connection request message including a first access terminal identifier and a first time identifier from the first access terminal;
comparing a time information of the received first time identifier to a current system time of the access network;
if the time information precedes the current system time, checking whether or not the second access terminal is using an identical access terminal identifier to the received first access terminal identifier;
if the second access terminal is using the identical access terminal, comparing the time information of the first time identifier to a reset time of the access network; and
if the time information precedes the reset time, broadcasting a session close message including the first access terminal identifier and the first time identifier to the first access terminal.

14. The method of claim 13, further comprising broadcasting the session close message including the first access terminal identifier and the first time identifier to the first access terminal if the time information is later than the current system time.

15. The method of claim 13, further comprising performing a data service on the first access terminal if the second access terminal is not using the identical access terminal.

16. The method of claim 13, further comprising broadcasting another session close message including a second access terminal identifier and the second time identifier to the second access terminal if the time information is later than the reset time as a result of the comparison.

17. A method of avoiding collisions in a mobile communication system having an access network and at least one access terminal, comprising:
receiving, via the at least one access terminal, a session close message including an access terminal identifier and a time identifier from the access network;
comparing the received access terminal identifier to an access terminal identifier stored in the at least on access terminal;
if the received access terminal identifier is identical to the stored access terminal identifier, comparing the received time identifier to a stored time identifier corresponding to the stored access terminal identifier of the at least one access terminal; and
if the received access time identifier is identical to the stored access time identifier, initializing the stored access terminal identifier and the stored time identifier of the at least one access terminal.

18. The method of claim 17, further comprising ignoring the session close message if the received access terminal identifier is not identical to the stored access terminal identifier.

19. The method of claim 17, further comprising ignoring the session close message if the received time identifier is not identical to the stored time identifier.

20. The method of claim 17, further comprising receiving the message including the access terminal identifier and the time identifier via a control channel.

21. A method of avoiding collisions in a mobile communication system having an access network and at least a first and a second access terminal, comprising:
allocating, by the access network, a first access terminal identifier including a first time identifier to the first access terminal;
initializing an access terminal identifier database of the access network;
requesting, by the second access terminal, a data service to the access network using a corresponding second access terminal identifier, which is identical to the first access terminal identifier, and a second time identifier, which is different than the first time identifier;
broadcasting by the access network a session close message including the second access terminal identifier and the second time identifier to the second access terminal; and
closing a session and initializing the access terminal identifier and the first time identifier by the first access terminal.
